(19) United States
(12) Patent Application Publication
(10) Pub. No.: US 2024/0106166 A1
(43) Pub. Date: Mar. 28, 2024

(54) AUTOMATED SYSTEM FOR THE CONNECTION AND/OR DISCONNECTION OF THE POWER SUPPLY AND/OR DATA CONNECTION FOR REFRIGERATED CONTAINERS

(71) Applicants: PIERLUIGI CURLETTO, GENOVA (IT); VINCENZO MINOPOLI, GENOVA (IT); LORENZO LAMPIS, GENOVA (IT); GIOVANNI MAPELLI, GENOVA (IT)

(72) Inventors: PIERLUIGI CURLETTO, GENOVA (IT); VINCENZO MINOPOLI, GENOVA (IT); LORENZO LAMPIS, GENOVA (IT); GIOVANNI MAPELLI, GENOVA (IT)

(73) Assignee: ARMS S.R.L., GENOVA (IT)

(21) Appl. No.: 18/265,282

(22) PCT Filed: Dec. 3, 2021
(86) PCT No.: PCT/IB2021/061280

§ 371 Date: Jun. 5, 2023

(30) Foreign Application Priority Data
Dec. 4, 2020 (IT) 102020000030047
Dec. 4, 2020 (IT) 102020000030053

(51) Int. Cl. H01R 13/631; H01R 43/26

(52) U.S. Cl. CPC H01R 13/6315; H01R 43/26

(57) ABSTRACT

An automated system for the connection and/or disconnection of the power supply and/or data connection for refrigerated containers comprising at least a mechanical arm equipped with a movable connector and at least one socket provided on said refrigerated container, the mechanical arm being fixed to a support structure. The mechanical arm comprises a proximal end for attachment to the support structure, a distal end equipped with said movable connector, and at least two intermediate sectors of which a first sector is jointly connected to the proximal end by a first joint and a second sector is connected to the distal end, the two intermediate sectors being connected to each other in a movable way.

### CROSS REFERENCE TO RELATED APPLICATIONS

This application is a national stage of International Application No. PCT/IB2021/061280 filed on Dec. 3, 2021, which claims priority to Italian Patent Application No. 102020000030047 filed Dec. 4, 2020 and Italian Patent Application No. 102020000030053 filed Dec. 4, 2020, all of which is hereby incorporated by reference in its entirety.

### BACKGROUND

The present invention relates to an automated system for the connection and/or disconnection of the power supply and/or data connection for refrigerated, or reefer, containers, which system comprises at least one mechanical arm equipped with a movable connector and at least one socket provided on said refrigerated container.

Refrigerated containers are generally equipped with an electric compressor to maintain internal conditions such as temperature and humidity, controlled according to the type of goods stored therein. These internal conditions must be maintained during all phases of transport and intermediate storage, under penalty of deterioration and loss of load. This can also lead to consequent legal actions for compensation for damages and insurance costs for their coverage.

The refrigerated container requires an electrical connection for the compressor power supply and a data connection for setting the operating parameters and for their monitoring, transmission and recording.

Both the container storage sites and container transport facilities must have electrical outlets to power the refrigerated containers, ensuring the connection, storage and monitoring of the setting parameters.

Storage of these containers in the port area is facilitated mostly by dedicated structures called “reefer racks” consisting of metal joinery structures used to position reefer containers in appropriately equipped and dedicated yard areas and including gangways to ensure personnel can access the refrigerated containers. The reefer racks are equipped with power supply points in a number equal to the storage capacity of the containers. These structures allow operators access to containers that can therefore be stored on multiple levels in areas served by mechanical means (for example, rail or wheeled cranes) used for their movement.

Every movement currently requires human intervention to connect and/or disconnect the container to/from the power supply network and this event occurs not only when the container is received or delivered, but also during discarding processes related to the movement of containers underneath others stacked on top of them.

These elements are also present on board ship when embarking or disembarking the container.

The need for constant human presence in high-risk port areas, due to the simultaneous presence of container lifting and handling means, creates a serious work safety problem for connection and disconnection of refrigerated containers. Safety in ports or in storage and interchange areas is an absolute priority, since port activities are intrinsically dangerous due to the commingling between human activities and operational means in the yards.

A further critical element is given by the numerous disputes related to damage arising from delays in the connections as a consequence of a lack of synchronization between the movements of the refrigerated containers and their connection to the power supply, resulting in the loss of the set temperature and humidity parameters with consequent deterioration of goods and related legal actions, with direct costs linked to the reimbursement of deductibles and indirect costs related to insurance premiums for risk coverage. Synchronization of the handling of the containers with the connection and disconnection of the power supply is therefore particularly critical for maintaining the quality of the service.

These critical issues are also present on board ship where the increased dimensions of the hold capacity can lead to high volumes of unloading of refrigerated containers with high risks of lack of synchronization between the disconnection of the power supply and the actual movement of the container, thus involving the same problems (described above) in terms of work safety, costs and quality of service that are found in the port area (container terminal side).

Since the trend of refrigerated goods is growing strongly and the size of container ships and the related landing volumes is growing more and more, the criticality related to the automation of refrigerated container connections and the synchronization between the electrical connection and their actual handling always assumes greater relevance for all the actors involved in the process.

The prior art is aware of systems for the automation of the activities necessary for the connection and disconnection of refrigerated containers, as regards both power supply and data connection.

Document JP2011205780A discloses a system for the automated connection and disconnection of reefer power supply by way of a means for connecting the magnetic induction power supply, in particular a primary coil fixed in a movable way to the reefer rack and a secondary coil fixed to the reefer. The movable coil is moved by hydraulic cylinders so that it can be brought closer to the fixed coil when the reefer is in place.

However, this system is complex, costly and inefficient because it is based on the transmission of electricity by magnetic induction and does not allow data transmission.

Documents WO2019/224792 and WO2019/224793 disclose power and data transmission systems using connectors moved by mechanical arms.

However, there is currently an unmet need to develop highly efficient systems that are both easy to build and inexpensive.

### BRIEF DESCRIPTION

The present invention aims to improve systems known to the prior art with a system which is cost-effective and which at the same time can guarantee high performances.

The present invention achieves these purposes with a system as disclosed at the beginning, wherein furthermore the mechanical arm is attached to a supporting structure and said mechanical arm comprises a proximal end for attachment to the supporting structure, a distal end equipped with said movable connector, and at least two intermediate sectors of which a first sector is jointly connected to the proximal end by a first joint and a second sector is connected to the distal end, the two intermediate sectors being movably connected to each other.

In constructive terms, the mechanical arm is therefore very simple and allows two alternative operating conditions: a withdrawn or resting condition in which the arm is retracted and the two sectors are substantially superimposed on each other, and a deployed or working condition in which the arm is operating and the distal end is positioned in such a way as to place the movable connector close to the socket on the container.

The mechanical arm preferably comprises only two intermediate sectors.

In a preferred embodiment, the first sector is connected to the second sector by a second joint.

In a further embodiment, the second sector is connected to the first sector in a translatable manner with respect to said first sector. The translation can be carried out along an axis coinciding with or parallel to the longitudinal axis of the first sector, for example in a telescopic manner.

In one embodiment, said socket is equipped with a plurality of circularly symmetrical electrical contact members adapted to transmit electricity and exchange signals at any relative angular position between said distal end and said socket.

In this way, it is possible not to have a rotating joint between the distal end and the second sector, with the associated checks on the relative position between the distal end and the second sector. Once the arm has been deployed in the working condition, the inclination of the distal end and, consequently, of the movable connector with respect to the vertical, is irrelevant for the connection of the electrical contacts of the movable connector with the corresponding electrical contacts of the socket. The connection is in fact guaranteed for every possible inclination thanks to the annular electrical contacts of the socket.

Alternatively or in a combination, an articulated joint can be inserted between the distal end and the second sector. In this case, the mechanical arm comprises three articulated joints: one between the proximal end and the first intermediate sector, one between the two intermediate sectors and one between the second intermediate sector and the distal end. This allows the movable connector to be precisely oriented in the correct position with respect to the socket.

According to a further embodiment, the sectors are rotatable on two planes parallel to each other and perpendicular to the direction of insertion of the movable connector into the socket.

In this way, the sectors must not be oriented in the three dimensions of space, with the consequent need for joints with several degrees of freedom, but must merely be rotated on planes in such a way as to move from the rest condition to the working condition. This ensures a high degree of simplicity in construction.

In one embodiment, the proximal end is equipped with translation means along an axis parallel to the direction of insertion of the movable connector into the socket.

In this way, the entire mechanical arm, and in particular the movable connector, can be moved towards or away from the container. This, in combination with the rotation of the sectors described above, allows precise positioning of the movable connector in front of the socket on the container.

In a further embodiment, the mechanical arm is movable from said withdrawn condition to said deployed condition, with a fixed casing being provided to cover the movable connector when the arm is positioned in the withdrawn condition.

The combined use of sector rotation and translation means allows the movable connector to be inserted into said casing when the arm is positioned in the rest condition. This has a double advantageous effect: firstly, the electrical contacts of the movable connector are protected from atmospheric agents, which in the marine environment can be very aggressive; secondly, the electrical contacts remain isolated from any possible contact with an operator, thereby increasing safety.

In one embodiment, the first and the second sectors consist of box members.

The use of box members, preferably commercially available standard size metal profiles, allows a further reduction in the overall costs of the mechanical arm.

In a further embodiment, the first joint provided between the proximal end and the first sector is fitted with a first electric drive motor.

In this way, the first motor makes it possible to rotate the first sector with respect to the proximal end, with the fulcrum in the first joint.

In a further embodiment, the second joint provided between the first sector and the second sector is fitted with a second electric drive motor.

In this way, the second motor allows the second sector to be driven in rotation with respect to the first sector, with the fulcrum in the second joint.

In an alternative embodiment, two said first sectors are provided and connected to the proximal end by a first joint and two said second sectors connected by joints to the distal end, the four intermediate sectors being connected to each other in a diamond shape configuration by two said second joints.

According to an improvement, the first joint is equipped with two drive motors for the two said first sectors respectively.

The electric motors and means of translation described above are controlled by a control and drive unit, which unit is connected to a pointing system, from which it receives data regarding the relative position between the movable connector and the socket. The pointing system preferably includes a camera and/or other sensors that operate with radio, inductive, magnetic, acoustic, laser waves, etc.

The present invention also achieves the aforementioned purposes with a system as described at the beginning, wherein the mechanical arm is configured to move a distal end equipped with said movable connector, wherein the movable connector is equipped with a truncated conical outer body for insertion and the socket is equipped with a housing of said body complementary to the body itself.

In this way, reduced misalignments between the final position into which the movable connector is carried and the position of the socket can be compensated for when inserting the connector into the socket itself by sliding the outer walls of the truncated conical body onto the perimeter walls of the housing. The walls of the housing thereby act as a guide for converging any possible misaligned initial position towards a single end position of contact between the movable connector and the socket, in which the reciprocal contact members establish an electrical connection.

In an exemplary embodiment, the distal end is equipped with a linear actuator for moving the movable connector in the direction of insertion of the movable connector into the socket.

In this way, when, thanks to the rotational-translational movements of the arm, the distal end is positioned in such a way as to place the movable connector in a position directly facing the socket, the movable connector can be inserted into the socket by means of a translation performed by the linear actuator.

According to one improvement, the linear actuator is connected to the distal end and the movable connector respectively by means of two ball joints.

This gives the necessary degrees of freedom for the movable connector to converge to its final position of contact with the socket during translation, thanks to interaction between the body and the housing.

In a further embodiment, the movable connector is equipped with removable means for interlocking said body into said housing, which interlocking means can be activated automatically when the body is fully inserted into the housing.

According to a still further embodiment, the movable connector is fitted with an electrical contact support member, which support member is movable from a retracted condition to an exposed condition when said interlocking means are activated, such that when the body is fixed into the housing the linear actuator moves the electrical contact support member to the exposed position, in which exposed position the electrical contacts of the movable connector are connected to the electrical contacts of the socket.

In an exemplary embodiment, said socket is equipped with a plurality of annular electrical contacts.

In this way, the inclination of the distal end and, consequently, of the movable connector with respect to the vertical is irrelevant for the connection of the electrical contacts of the movable connector to the corresponding electrical contacts of the socket. The connection is in fact guaranteed for every possible inclination thanks to the annular electrical contacts of the socket.

In an exemplary embodiment, said socket comprises an outer junction box, said housing being positioned within said outer junction box and connected by elastic means to said outer junction box.

This allows the socket a predetermined freedom of movement, and it may in fact rotate or translate slightly to facilitate insertion of the movable connector.

In one embodiment, the distal end and the socket are equipped with wireless communication means configured for identification of the relative position between the distal end and the socket.

According to one improvement, the distal end is equipped with a camera.

The wireless communication means and/or the camera form a pointing system, and are connected to a control and actuation unit, which unit receives data from the pointing system regarding the relative position between movable connector and socket and commands the mechanical arm to move the distal end so as to bring it to the socket.

In a first embodiment variant, the distal end can be connected to the mechanical arm by grasping means provided on the mechanical arm.

In a second embodiment variant, the distal end is integral with the free end of the mechanical arm.

### BRIEF DESCRIPTION OF THE DRAWINGS

These and other features and advantages of the present invention will become clearer from the following description of some non-limiting exemplary embodiments illustrated in the attached drawings wherein:

FIG. 1 shows an overall view of an exemplary embodiment of the system;

FIGS. 2 to 6 illustrate the different positions taken by the mechanical arm;

FIGS. 7 and 8 illustrate different views of a further embodiment;

FIG. 9 shows a schematic cross-sectional view of an exemplary embodiment of the distal end;

FIG. 10 shows a schematic cross-sectional view of a further embodiment of the distal end;

FIG. 11 shows a schematic cross-sectional view of a further embodiment of the distal end;

FIG. 11 illustrates an embodiment of the system;

FIG. 12 illustrates a further embodiment of the system;

### DETAILED DESCRIPTION

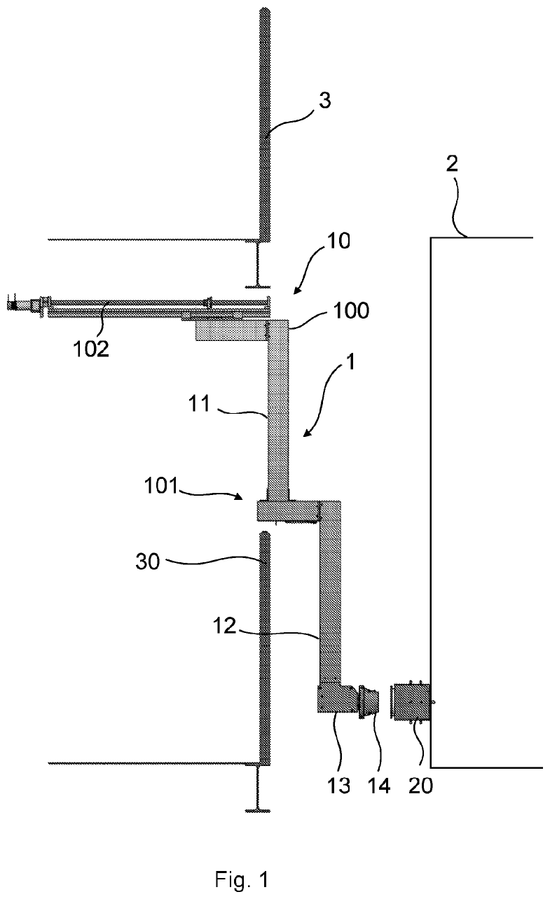

FIG. 1 illustrates an embodiment of the automated system for the connection and/or disconnection of the power supply and the data connection for refrigerated containers 2 according to the present invention. The system comprises a mechanical arm 1 fixed to a support structure 3, for example a reefer rack. The mechanical arm 1 has a proximal end 10 for attachment to the rack reefer 3 and a free distal end 13 moveable in space. The distal end 13 is equipped with a movable connector 14 adapted for connection to a socket 20 provided on the refrigerated container 2. The socket 20 may be constituted by an outer, fixed or removable junction box, or be integrated into the container 2. The socket 20 and the movable connector 14 are equipped with the electrical contacts necessary for both the power supply and the data connection.

The mechanical arm 1 comprises two intermediate sectors, of which a first sector 11 is jointly connected to the proximal end 10 by a first joint 100 and a second sector 12 is connected to the distal end 13. The two intermediate sectors are interconnected by means of a second joint 101.

The first sector 11 and the second sector 12 consist of metal profiles that form box members with a square section and are fitted with appropriate fastening members and plates at the ends for connection to the other components of the mechanical arm 1. Sectors 11 and 12 may have any section.

The first joint 100 and the second joint 101 have rotation axes parallel to the direction of insertion of the movable connector 14 into the socket 20. The intermediate sectors 11 and 12 are therefore rotatable on two planes parallel to each other and perpendicular to that insertion direction.

The first joint 100 and the second joint 101 are equipped with a first drive motor and a second drive motor, preferably electric motors, respectively.

By the action of the motors on the joints 100 and 101, the mechanical arm 1 is movable from a withdrawn condition to a deployed condition.

In the example illustrated in the Figure, the proximal end 10 is connected to the reefer rack in a raised position, such that the arm deploys downwards. In particular, for the positioning of a container on a reefer rack 3, the arm is connected to the carpentry of the gangway immediately above. This configuration is particularly advantageous because, in a withdrawn condition, the movable connector 14 and the entire mechanical arm 1 are out of reach of any operator present on the reefer rack 3. A further advantage is that the mechanical arm 1 can be installed without any impact on the existing spaces and in particular on reefer rack 3 items, such as railings 30, or on existing systems.

It is, however, possible to have a mechanical arm 1 at the level of the gangway corresponding to the position of the container, for example by modifying the railings 30 to allow for movements of the mechanical arm 1.

The proximal end 10 is equipped with means of translation along an axis parallel to the direction of insertion of the movable connector 14 into the socket 20. In the example given in the Figures, the means of translation comprise a carriage 102 activated by at least one linear actuator and movable on rails firmly fixed to the reefer rack 3.

The linear actuator can be of any type, e.g. recirculating ball bearing, screw or ball screw-driven, rack-and-pinion or hydraulic cylinder.

A fixed casing, not shown in the Figures, is provided in the vicinity of the proximal end 10. Said fixed casing is preferably fixed to the reefer rack 3 and is suitable for covering the movable connector 14 when the mechanical arm 1 is positioned in the withdrawn condition.

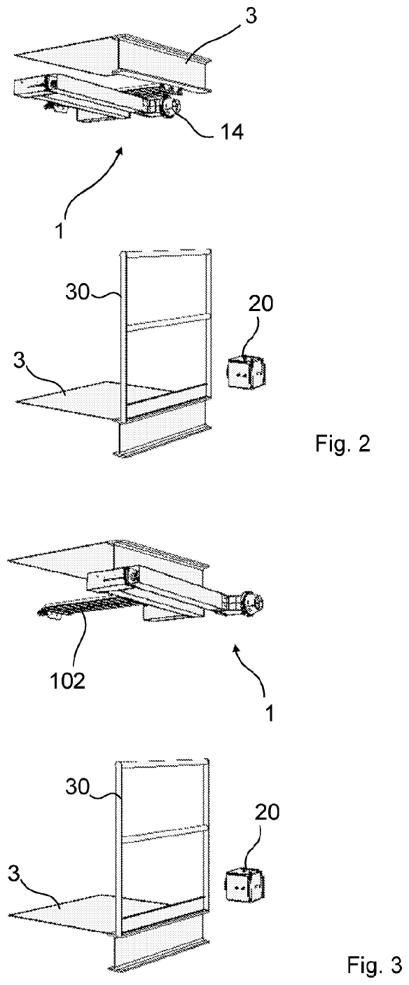

When the mechanical arm 1 is inactive, it is placed in the withdrawn condition shown in FIG. 2, with the movable connector 14 inside the fixed casing. In this condition, the mechanical arm 1 has a minimum total encumbrance, is in a position away from the gangway of the reefer rack 3 and has the contacts of the movable connector 14 protected from accidental physical contact by an operator and from bad weather.

An electronic control unit is provided for controlling the movements of the mechanical arm, which drives all the actuators to perform the various operations.

When the mechanical arm 1 is activated, the first step is to perform a translation of the carriage 102 in the direction away from the refrigerated container 2. In this way, the movable connector 14 is extracted from the casing.

The carriage 102 then makes a further translation, this time in the direction of the container 2, so as to move to the position shown in FIG. 3.

Once these translations have been completed, the motors are activated to deploy the mechanical arm 1. As is obvious to anyone skilled in the art, the further translation in the direction of the container 2 can take place before complete deployment of the arm, during deployment or when deployment has been completed.

To deploy the mechanical arm 1, the first motor rotates the first sector 11 downward relative to the proximal end 10 and the carriage 102, bringing the arm to the position shown in FIG. 4.

Subsequently or simultaneously, the second motor rotates the second sector 12 downwards with respect to the first sector 11, as illustrated in FIG. 5.

These movements continue until the distal end 13 and consequently the movable connector 14 are positioned near the socket 20 on the container 2, ready to be inserted, as shown in FIG. 6.

The control unit includes a visual feedback system for real time detection of the position of the distal end and for its correct setting. The visual feedback system preferably comprises an overhead camera: this camera can in fact operate both for the positioning of the mechanical arm 1 and for surveillance of the work area. Alternatively or in a combination, a pointing system may be provided on the distal end 13, comprising a camera and/or a laser pointer and/or a proximity sensor based on various technologies.

In the preferred embodiment illustrated in the Figures, the distal end 13 is attached without joints to the second sector 12. This configuration considerably simplifies the mechanical arm 1 and makes it economically advantageous.

The socket 20 is equipped with a plurality of annular electrical contact members adapted to come into contact with corresponding members on the movable connector 14. The contact members of the movable connector 14 are preferably pins stressed in the direction of contact by springs, in order to make contact with the annular members of the socket 20 with their own head surface. Alternatively, it is possible to provide annular contact members on the movable connector 14 and pins in the socket 20, or annular contact members on both the movable connector 14 and the socket 20.

To disconnect, the movable connector 14 is removed from the socket 20. The control unit then drives the first and second motors to bring the mechanical arm 1 into the withdrawn condition. With the translations performed by the carriage 102, the movable connector 14 is positioned within the fixed casing.

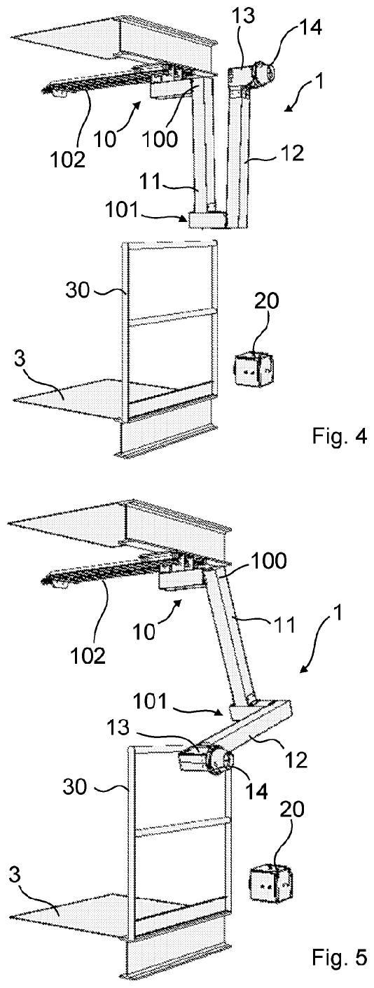

FIGS. 7 and 8 illustrate a further example embodiment in which two first sectors 11 are provided and connected to the proximal end 10 via a first joint 100 and two said second sectors 12 connected to the distal end 13 via a third joint 103. The four intermediate sectors 11 and 12 are therefore jointed in a diamond configuration, by means of two said second joints 101.

The first joint 100 is equipped with two drive motors for the two first sectors 11 respectively.

The first joint 100 consists of two coaxial cylindrical sectors inserted advantageously into each other, which cylindrical sectors are connected to the output shafts of the rotary electric drive motors of the diamond.

By rotating the first two sectors independently of each other, the angles of the diamond and its orientation can be adjusted, and the position of the lower end of the diamond, consisting of the distal end 13, can be fixed precisely.

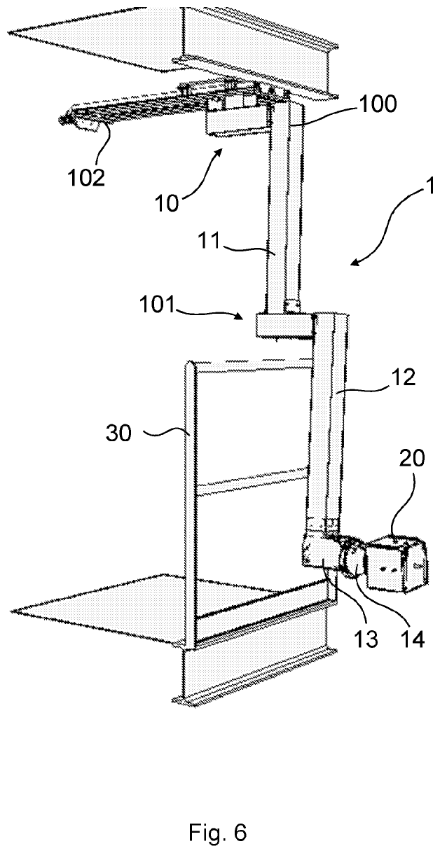

FIGS. 9 to 13 illustrate various embodiments of the automated system for the connection and/or disconnection of the power supply and the data connection for refrigerated containers 2 according to the present invention. The system comprises a mechanical arm 1 adapted to move a free distal end 13. The distal end 13 is equipped with a movable connector 14 adapted for connection to a socket 20 provided on the refrigerated container 2. The socket 20 is preferably formed by an outer, fixed or removable electric junction box, which can also be integrated into the container 2. The socket 20 and the movable connector 14 are equipped with the electrical contacts necessary for both the power supply and the data connection.

The arm being connected makes movements to bring the distal end 13 and consequently the movable connector 14 into the vicinity of the socket 20 on the container 2, hence now ready to be inserted, as shown in FIGS. 9, 10 and 11.

A control unit including a visual feedback system is provided for real time detection of the position of the distal end 13 and for its correct setting. The visual feedback system may preferably comprise an overhead camera: this camera can in fact operate both for the positioning of the mechanical arm 1 and for surveillance of the work area. Alternatively or in combination, a pointing system may be provided on the distal end 13, comprising a camera and/or a laser pointer and/or a proximity sensor.

The pointing system preferably comprises means of wireless communication configured to identify the relative position between the distal end 13 and the socket 20. Such communication means may include, for example, electromagnetic loops 70 and 71 for recognition of the socket 20 and centring of the distal end 13 with respect to the socket 20.

The socket 20 may be purely passive or powered, for example, by a rechargeable battery.

The movable connector 14 is equipped with a plurality of annular electrical contact members 140 adapted so as to come into contact with corresponding members 200 on the socket 20. The contact members 200 of the socket 20 are preferably pins stressed in the contacting direction by springs, to contact the annular members 140 of the movable connector 14 with their own head surface. It is, however, alternatively possible to provide annular contact members on the socket 20 and pins on the movable connector 14 or annular contact members on both the movable connector 14 and the socket 20.

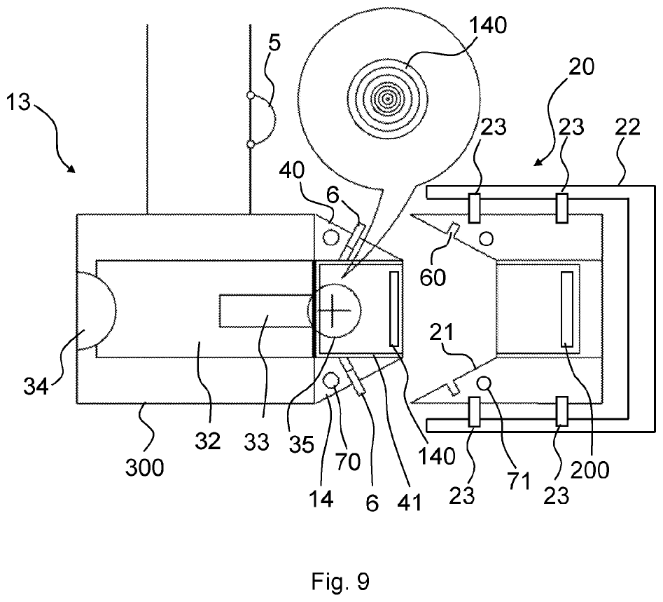

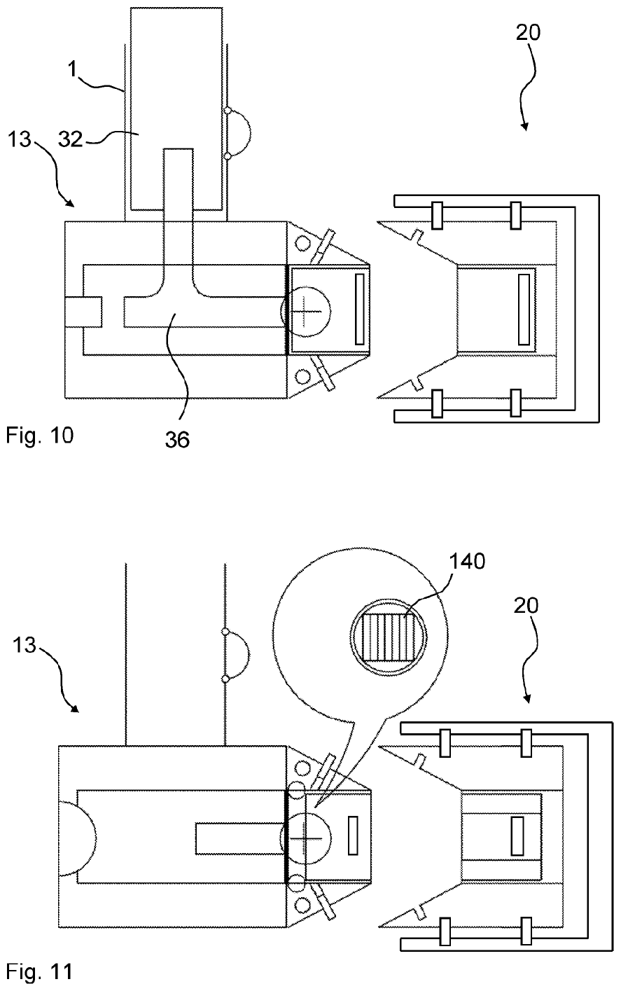

Alternatively, as illustrated in FIG. 11, it is possible to provide rectangular-shaped contacts both on the movable connector 14 and in the socket 20. In this case, the contacts in the movable connector are equipped with a gyroscope or a free rotation system such as to be positioned according to gravity in a position corresponding to that of the contacts of the socket 20 regardless of the orientation of the distal end 13.

The distal end 13 comprises a housing box 300 of a linear actuator 32 for moving the movable connector 14 in the direction of insertion into the socket 20. The housing box 300 has an outlet hole for an actuating shaft 33 belonging to the linear actuator 32, which shaft 33 is connected to the movable connector 14. The housing box 300 is preferably manufactured in two half-shells coupled to each other.

The movable connector 14 is equipped with a truncated conical outer body 40 for insertion into the socket 20, and the socket 20 is equipped with housing 21 for said body 40 complementary to the body 40 itself.

The linear actuator 32 is connected respectively to the distal end 13 and the movable connector 14 via two ball joints 34 and 35.

The movable connector 14 is equipped with removable means for interlocking the body 40 into the socket 20. Such interlocking means can be activated automatically when the body 40 is completely inserted into the housing 21.

The movable connector 14 is equipped with a support member 41 for the electrical contacts housed in a translatable manner along the direction of insertion into the socket 20 inside the body 40. The support member 41 can be moved from a retracted condition to an exposed condition when said interlocking means are activated. In this manner, when the body 40 is secured into the housing 21, the linear actuator 32 moves the support member 41 of the electrical contacts to the exposed position; in this exposed position the electrical contacts 140 of the movable connector 14 are in contact with the electrical contacts 200 of the socket 20.

In a preferred embodiment, the interlocking means comprise a plurality of pins 6 constrained to the body 40 in an oscillating manner such that in an inactive condition they do not protrude beyond the external surface of the body 40. The plugs can be automatically operated by any means of activation known to experts in the field. Preferably, when the linear actuator 32 moves the support member 41 of the electrical contacts inside the body 40 in the direction of insertion into the socket 20, the support member 41 interacts with a surface of pins 6 and pushes them outwards, causing them to be pressurized on the inner surface of the socket housing 20 or in special housings 60. Once the pins 6 hold the body 40 in the socket housing 20, the linear actuator 32 completes its excursion by bringing the support member 42 of the electrical contacts into the exposed end position, in which the electrical contacts 140 of the movable connector 14 are connected to the electrical contacts 200 of the container's 2 socket 20.

The interlock effected by the pins 6 ensures that the pressure of the electrical contacts 140 of the movable connector 14 on the respective electrical contacts 200 of the socket 20 does not cause a reaction which moves the entire mechanical arm 1 away from the socket 20.

However, it is possible not to have any actuator and to have the contacts of the movable connector 14 already exposed: with a movement of the entire distal end 13, the body 40 is inserted into the socket 20.

The socket 20 comprises an outer junction box 22 and electrical contacts, said housing being located inside said outer junction box 22 and connected by elastic means to the outer junction box 22. The elastic means may advantageously be springs 23 or the like.

It is possible to provide, alternatively or in combination, removable coupling means of the magnetic type between the movable connector 14 and the socket 20. According to an exemplary embodiment, the socket housing 20 is equipped with one or more permanent magnets while the body 40 is equipped with one or more electromagnets. This configuration can be modified by inverting permanent magnets and electromagnets, providing only electromagnets, or replacing the permanent magnets with ferromagnetic members.

To disconnect, the linear actuator 32 withdraws the support member 41 of the electrical contacts, thereby interrupting the connection. When the support member 41 of the electrical contacts passes over the pins 42, these are no longer stressed outward and therefore deactivate the interlock, releasing the body 40 from the socket 20 housing. Once unconstrained, the movable connector 14 is withdrawn to the box 300. The control unit then activates the mechanical arm 1 to bring it into the withdrawn condition.

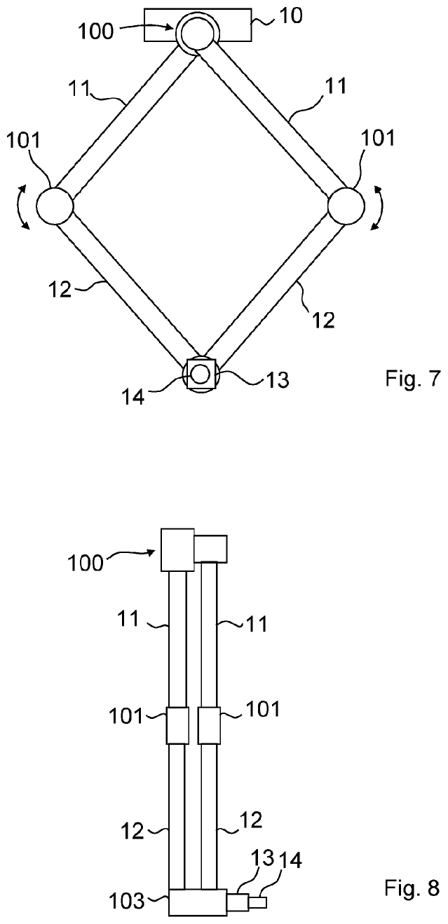

In the executive embodiment shown in FIG. 10, the distal end 13 is attached to a sector of the mechanical arm 1 and the linear actuator 32 is inserted into said sector and connected by a mechanical bevel gear 36 to the movable connector 14.

As shown in FIG. 1, the distal end 13 can be part of an arm 1 fixed to a support structure 3, for example a reefer rack. The mechanical arm 1 has a proximal end 10 for attachment to the reefer rack 3 by means of a carriage 100 translatable in the direction of insertion of the movable connector 14 into the socket 20.

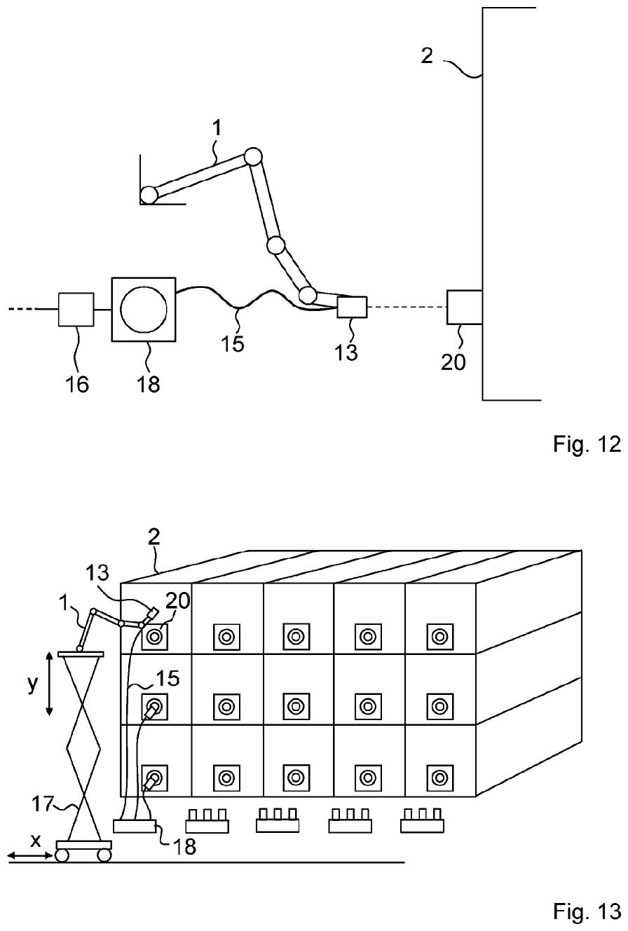

In FIG. 12 the mechanical arm 1 is translatable, being capable of grasping a plurality of distal ends 13 in a reefer rack. Each slot of the rack is equipped with its own cable 15, wound on a rewinder drum 18 and positioned on the rack's structure, which ends with a distal end 13 fitted with a movable connector 14 which is managed by the robotic arm 1 for connection to the socket 20 installed on the container 2.

Having received the order from the Terminal Operating System (TOS), the mechanical arm 1 grasps the distal end 13 equipped with the movable connector 14 by unwinding the cable 15 from the rewinder drum 18 and connects the movable connector 14 to the socket 20. For disconnection, the movable connector 14 is released from the socket 20 and the distal end 13 is returned to the rest position by the mechanical arm 1 and/or the rewinder 18.

In FIG. 13 there is no reefer rack and the containers 3 are stacked one on top of the other. A plurality of terminal devices 13 with respective movable connectors 14 is arranged in front of each column of containers 3, preferably in the same quantity as the number of containers in the column. Each movable connector 14 is connected to the electrical power distribution and/or data transmission network by a cable 15, preferably wound onto a rewinder 18.

The mechanical arm 1 is placed on a translatable carriage 17 equipped with lifting means. The mechanical arm 1 is equipped with grasping means, for example a gripper, on its free end. The mechanical arm 1 can thus grasp the distal end 13 from its original position, move it to the socket 20, insert the movable connector 14 and make the connection. In the same way, the movable connector 14 can be extracted from the socket 20 by disconnecting it, and the distal end 13 can be returned to its original position.

1. An automated system for the connection and/or disconnection of the power supply and/or data connection for refrigerated containers comprising at least a mechanical arm equipped with a movable connector and at least a socket provided on said refrigerated container, the mechanical arm being fixed to a support structure,
wherein the mechanical arm comprises a proximal end for attachment to the support structure, a distal end equipped with said movable connector, and at least two intermediate sectors of which a first sector is jointly connected to the proximal end by a first joint and a second sector is connected to the distal end, the two intermediate sectors being connected to each other in a movable way.

2. The system according to claim 1, wherein the first sector is connected to the second sector by a second joint.

3. The system according to claim 1, wherein the second sector is connected to the first sector in a translatable manner with respect to said first sector.

4. The system according to claim 1, wherein said socket is equipped with a plurality of circularly symmetrical electrical contact members adapted to transmit electricity and exchange signals at any relative angular position between said distal end and said socket.

5. The system according to claim 1, wherein the proximal end is equipped with translation means along an axis parallel to the direction of insertion of the movable connector into the socket.

6. The system according to claim 1, wherein the mechanical arm is movable from a withdrawn condition to a deployed condition, a fixed cover casing of the movable connector being provided when the mechanical arm is positioned in the withdrawn condition.

7. The system according to claim 1, wherein the sectors are rotatably placed on two planes parallel to each other and perpendicular to the insertion direction of the movable connector into the socket.

8. The system according to claim 7, wherein the first joint is equipped with a first electric drive motor and the second joint is equipped with a second electric drive motor.

9. The system according to claim 7, wherein two said first sectors are provided and connected to the proximal end by a first joint and two said second sectors are connected by joints to the distal end, the four intermediate sectors being connected to each other in a diamond configuration by means of the two said second joints.

10. The system according to claim 9, wherein the first joint is equipped with two drive motors for the two first sectors respectively.

11. An automated system for connecting and/or disconnecting electric power and/or data connection for refrigerated containers comprising at least one mechanical arm adapted to move a movable connector and at least one socket provided on said refrigerated container,
wherein the mechanical arm is configured to move a distal end equipped with said movable connector, wherein the movable connector is equipped with a truncated conical outer body for insertion and the socket is equipped with housing for said body complementary to the body itself.

12. The system according to claim 11, wherein the distal end is equipped with a linear actuator for moving the movable connector in the direction of insertion of the movable connector into the socket.

13. The system according to claim 12, wherein the linear actuator is connected respectively to the distal end and to the movable connector by means of two ball joints.

14. The system according to claim 13, wherein the movable connector is equipped with removable interlocking means of said body into said housing, which interlocking means can be activated automatically when the body is fully inserted into the housing.

15. The system according to claim 14, wherein the movable connector is equipped with a support member for the electrical contacts, which support member is movable from a retracted condition to an exposed condition when said interlocking means are activated, in such a way that when the body is fixed into the housing the linear actuator moves the support member of the electrical contacts to the exposed position, in which exposed position the electrical contacts of the movable connector are connected to the electrical contacts of the socket.

16. The system according to claim 11, wherein said socket comprises an outer junction box, said housing being positioned inside said outer junction box and connected by elastic means to said outer junction box.

17. The system according to claim 11, wherein the distal end and the socket are equipped with wireless communication means configured for identifying the relative position between the distal end and the socket.

18. The system according to claim 11, wherein the distal end is equipped with a camera.

19. The system according to claim 11, wherein the distal end can be connected to the mechanical arm by grasping means provided on the mechanical arm.

20. The system according to claim 11, wherein the distal end is integral with the free end of the mechanical arm.

21. The system according to claim 11, wherein said socket is equipped with a plurality of circularly symmetrical electrical contact members adapted to transmit electricity and exchange signals at any relative angular position between said distal end and said socket.

22. The system according to claim 11, which has the characteristics according to claim 1.
